(19) United States
(12) Patent Application Publication
(10) Pub. No.: US 2024/0344174 A1
(43) Pub. Date: Oct. 17, 2024

(54) RECOVERY OF LITHIUM FROM LITHIUM IRON PHOSPHATE BLACK MASS

(71) Applicant: GLENCORE LTD., New york, NY (US)

(72) Inventor: Sumedh GOSTU, Stamford, CT (US)

(73) Assignee: GLENCORE LTD., New York, NY (US)

(21) Appl. No.: 18/632,809

(22) Filed: Apr. 11, 2024

Related U.S. Application Data
(60) Provisional application No. 63/458,736, filed on Apr. 12, 2023.
(60) Provisional application No. 63/495,606, filed on Apr. 12, 2023.

(51) Int. Cl. C22B 26/12; C01D 15/02; C01D 15/08; C22B 1/02; C22B 7/00

(52) U.S. Cl. CPC C22B 26/12; C01D 15/02; C01D 15/08; C22B 1/02; C22B 7/007

(57) ABSTRACT

LiFePO₄ or LiMnₓFe₍₁₋ₓ₎PO₄-containing black mass or a material that is derived from LiFePO₄ or LiMnₓFe₍₁₋ₓ₎PO₄-containing black mass is acid baked or salt baked and leached with water to extract Li⁺, one or more types of non-lithium cations, and SO₄²⁻. A basic reagent is added to the acidic leachate to precipitate salts of the non-lithium cation(s) to form solid leachate tailings. After separating the lithium-enriched liquor from the solid leachate tailings to produce a product liquor, the product liquor is optionally contacted with a precipitation agent in order to precipitate product Li₂CO₃ or LiOH.

### CROSS-REFERENCE TO RELATED APPLICATIONS

This application claims the priority benefit of U.S. Provisional Patent Application No. 63/458,736 filed on Apr. 12, 2023 and U.S. Provisional Patent Application No. 63/495,606 filed Apr. 12, 2023, the entireties of which are incorporated by reference herein.

### FIELD

The present disclosure relates to recovery of lithium from black mass containing lithium iron phosphate (LiFePO₄) and similar black masses including lithium manganese iron phosphate (LiMnₓFe₍₁₋ₓ₎PO₄).

### BACKGROUND

Batteries and other devices include one or more electrochemical cells that convert chemical energy into electrical energy are an ever-present part of modern consumer and industrial technology. For example, conventional chemistries for secondary batteries which are also known as rechargeable batteries include lithium-ion, nickel-metal hydride, nickel-zinc, nickel-cadmium, and lead-acid, among others. Secondary batteries are used in numerous applications including gasoline-powered automobiles, hybrid electric vehicles, plug-in electric vehicles, industrial equipment, power tools, stationary power storage, power conditioning, and consumer electronics (for example, notebook computers, tablet computers, cellular telephones and smart phones, among other rechargeable electronic devices). Secondary batteries are designed to be charged and discharged repeatedly, though the efficiency of the charging and discharging typically degrades over time with each charging and discharging cycle, and some chemistries degrade with age. Eventually the efficiency of a secondary battery will have degraded to such an extent that the battery can no longer be used for its intended purpose.

In contrast, primary batteries are known as non-rechargeable, single use or disposable batteries. Examples of primary battery chemistries include alkaline batteries, lithium ion batteries (note that similar chemistries are also used for secondary batteries, described above), and zinc-carbon batteries. Primary batteries are used only once and cannot be recharged. Once the internal materials of a primary battery are consumed, the battery is depleted and cannot be recharged or used again.

Because both primary batteries and secondary batteries must eventually be disposed, the widespread use of batteries and other electrochemical cells (for example, electric double layer capacitors, also known as supercapacitors or ultracapacitors) generates large electrochemical scrap waste streams. As such, the recycling of electrochemical scrap waste streams has become increasingly important from the perspectives of environmental sustainability and manufacturing economics. Because batteries and other electrochemical cell devices comprise scarce materials and various chemicals posing environmental contamination concerns, the recycling of electrochemical scrap waste from modern devices is important to advance goals of environmental protection and sustainability. Moreover, because batteries and other electrochemical cell devices frequently contain relatively expensive materials such as nickel, cobalt, or lithium compounds, and other expensive metals, alloys, and compounds, the recycling of electrochemical scrap waste is important for reducing the costs of manufacturing new batteries and electrochemical cells, which would otherwise require virgin materials.

Currently, the lithium ion family of battery chemistries has been widely adopted. Thus, many have proposed recovery of the materials from electrochemical scrap waste derived from lithium ion batteries. At the end of their useful lives, such lithium ion batteries are mechanically collected, discharged, and disintegrated. This generates plastic and metallic streams, which can be recycled directly by physical separation, leaving behind a small particle size fraction, known as black mass. The black mass contains anode materials (mainly graphite coated on copper foil), cathode materials (for example LiMO₂, LiNiₓMn_{y}Co_{z}O₂, or LiCoO₂, sometimes coated on aluminum foil, where M is a metal such as Mn, Ni, Co, Fe, Cr), binders (usually polyvinylidene fluoride), conductive additives (for example acetylene black), traces of electrolyte (typically, lithium salt dissolved in an organic solvent), and electrode current collector residuals (for example, copper and aluminum).

Within the family of lithium ion battery chemistries, LiCoO₂, LiFePO₄ and LiMnₓFe₍₁₋ₓ₎PO₄ are common. In particular, the LiFePO₄ chemistry has enjoyed recent interest because it does not include cobalt and therefore can be produced at much lower cost than LiCoO₂. Other benefits of LiFePO₄ chemistry include high safety, low toxicity, and long cycle life. However, because this molecular composition is relatively complex and the components are bound, recovery of any single component is from electrochemical scrap waste is challenging. Furthermore, any efforts to recover the components of LiFePO₄ would ideally be performed on existing equipment and with minimal modification to the processes that are presently employed to refine the β-spodumene ores that contain the lithium used in batteries.

### SUMMARY

The aspects described below are not limiting and can be applied to any methods described throughout the disclosure. In some aspects, the present disclosure relates to a method for recovering lithium from black mass containing LiFePO₄, and this method can include various steps. In some embodiments, a material comprising LiFePO₄ is acid baked in the presence of sulfuric acid at a temperature of 150-350° C., thereby producing an acid baked composition. Li⁺, one or more types of non-lithium cations, and SO₄²⁻ can be leached from the acid baked composition with water, thereby producing an acidic leachate comprising dissolved Li⁺, one or more types of non-lithium cations, and SO₄²⁻. In some /embodiments, the basic reagent can be added to the acidic leachate in one or more steps in order to precipitate salts of the non-lithium cation(s) and produce one or more solid leachate tailings comprising the precipitated salt(s) and a lithium-enriched liquor comprising solvated Li⁺ and SO₄²⁻. In some embodiments, the lithium-enriched liquor is separated from the one or more solid leachate tailing(s), thereby producing a product liquor comprising dissolved Li₂SO₄. In some embodiments, the material comprising LiFePO₄ is either LiFePO₄-containing black mass or LiFePO₄ that is derived from LiFePO₄-containing black mass. In some embodiments, the product liquor is contacted with a precipitation agent in order to precipitate Li₂CO₃ or LiOH and produce a lithium-depleted aqueous phase and product lithium comprising the precipitated Li₂CO₃ or LiOH. In some embodiments, the product lithium is separated from the lithium-depleted aqueous phase.

The method may include one or more of the following aspects which are described below.

In certain aspects of the disclosure, the material comprising LiFePO₄ is LiFePO₄-containing black mass.

In certain aspects of the disclosure, β-spodumene is also acid baked with the material comprising LiFePO₄.

In certain aspects of the disclosure, the material comprising LiFePO₄ is LiFePO₄ derived from LiFePO₄-containing black mass that is produced by decrepitating the LiFePO₄-containing black mass at a temperature of 800-1500° C., thereby producing said derived LiFePO₄.

In certain aspects of the disclosure, the LiFePO₄-containing black mass comprises 1-20 wt % lithium.

In certain aspects of the disclosure, the LiFePO₄-containing black mass comprises 1-10 wt % lithium.

In certain aspects of the disclosure, the LiFePO₄-containing black mass comprises 1-5 wt % lithium.

In certain aspects of the disclosure, the LiFePO₄-containing black mass comprises 1.5-3.5 wt % lithium.

In certain aspects of the disclosure, the LiFePO₄-containing black mass comprises 2.-2.8 wt % lithium.

In certain aspects of the disclosure, the LiFePO₄-containing black mass is decrepitated with a-spodumene, thereby transforming the a-spodumene to β-spodumene.

In certain aspects of the disclosure, the a-spodumene is derived from mined spodumene ore.

In certain aspects of the disclosure, Na₂CO₃, K₂CO₃, and/or CO₂ is added to the Li₂SO₄ product liquor, thereby producing a Li₂CO₃ precipitate and a supernatant and the Li₂CO₃ precipitate is separated from the supernatant, thereby producing a solid Li₂CO₃ product.

In certain aspects of the disclosure, NaOH, KOH, and/or Ca(OH)₂ is added to the Li₂SO₄ product liquor, thereby producing a LiOH precipitate and a supernatant and the LiOH precipitate is separated from the supernatant, thereby producing a solid LiOH product.

In certain aspects of the disclosure, the step of a basic reagent to the acidic leachate comprises the steps of: raising a pH of the acidic leachate to a first predetermined value, with an addition of a basic reagent, at which the one or more non-lithium salts are precipitated therefrom and at which Li₂SO₄ remains solvated therein; separating the precipitated non-lithium salt(s) from the acid leachate containing the dissolved Li₂SO₄; and raising a pH of the acidic leachate to a second predetermined value higher than said first predetermined value, with an addition of a basic reagent, at which Li₂SO₄ precipitates therefrom.

In certain aspects of the disclosure, the precipitation agent is CO₂, Na₂CO₃, and/or K₂CO₃ in order to precipitate Li₂CO₃.

In certain aspects of the disclosure, the precipitation agent is NaOH, Ca(OH)₂, and/or KOH in order to precipitate LiOH.

In certain aspects of the disclosure, the acid baking is performed in a rotary kiln.

In certain aspects of the disclosure, a gaseous oxidant such as air, oxygen-enriched air or industrially pure oxygen is injected into an interior of the rotary kiln.

In certain aspects of the disclosure, decrepitation is carried out at a temperature of 800-1500° C., and more typically 800-1200° C.

In certain aspects of the disclosure, acid baking or salt baking is performed within a range of temperatures that include a lower end thereof and an upper end thereof, wherein the lower end is selected from about 790° C., about 780° C., about 770° C., about 760° C., about 750° C., about 740° C., about 730° C., about 720° C., about 710° C., about 700° C., about 690° C., about 680° C., about 670° C., about 660° C., about 650° C., about 640° C., about 630° C., about 620° C., about 610° C., about 600° C., about 590° C., about 580° C., about 570° C., about 560° C., about 550° C., about 540° C., about 530° C., about 520° C., about 510° C., about 500° C., about 490° C., about 480° C., about 470° C., about 460° C., about 450° C., about 440° C., about 430° C., about 420° C., about 410° C., about 400° C., about 390° C., about 380° C., about 370° C., about 360° C., about 350° C., about 340° C., about 330° C., about 320° C., about 310° C., about 300° C., about 290° C., about 280° C., about 270° C., about 260° C., about 250° C., about 240° C., about 230° C., about 220° C., about 210° C., about 200° C., about 190° C., about 180° C., about 170° C., about 160° C., and about 150° C. and the upper end is selected from about 800° C., about 790° C., about 780° C., about 770° C., about 760° C., about 750° C., about 740° C., about 730° C., about 720° C., about 710° C., about 700° C., about 690° C., about 680° C., about 670° C., about 660° C., about 650° C., about 640° C., about 630° C., about 620° C., about 610° C., about 600° C., about 590° C., about 580° C., about 570° C., about 560° C., about 550° C., about 540° C., about 530° C., about 520° C., about 510° C., about 500° C., about 490° C., about 480° C., about 470° C., about 460° C., about 450° C., about 440° C., about 430° C., about 420° C., about 410° C., about 400° C., about 390° C., about 380° C., about 370° C., about 360° C., about 350° C., about 340° C., about 330° C., about 320° C., about 310° C., about 300° C., about 290° C., about 280° C., about 270° C., about 260° C., about 250° C., about 240° C., about 230° C., about 220° C., about 210° C., about 200° C., about 190° C., about 180° C., about 170° C., and about 160° C.

In certain aspects of the disclosure, the material comprising LiFePO₄ is acid baked in the presence of an additional sulfating agent in addition to the sulfuric acid.

In certain aspects of the disclosure, the additional sulfating agent is Na₂SO₄, Fe₂SO₃, NaHSO₄, or CaSO₄.

In certain aspects of the disclosure, a mol:mol ratio of sulfuric acid to additional sulfating agent ranges from 0.05:1 to 20:1.

In certain aspects of the disclosure, the material comprising LiFePO₄ is acid baked in the presence of an oxidizing agent in addition to the sulfuric acid.

In certain aspects of the disclosure, the oxidizing agent is a solid and is selected from potassium permanganate, potassium dichromate, sodium nitrate, potassium nitrate, ferric sulfate, and liquid hydrogen peroxide.

In certain aspects of the disclosure, the oxidizing agent is a gaseous and is selected from air, oxygen-enriched air, and industrially pure oxygen.

In certain aspects of the disclosure, the acid baking is performed in a rotary kiln and a stoichiometric excess of gaseous oxidant is injected into an interior of the kiln for combusting the fuel and for provide an oxidizing atmosphere.

In some aspects, the techniques described herein relate to a method for recovering lithium from electrochemical scrap waste or black mass containing LiFePO4 or LiMnxFe(1-x)PO4, the method including: acid baking or salt baking electrochemical chemical scrap waste or the black mass containing LiFePO4 or LiMnxFe(1-x)PO4 in the presence of sulfuric acid or sulfur containing salt at a temperature of about 150° C. to about 350° C. for acid baking or about 150° C. to about 1000° C. for salt baking, thereby producing an acid baked or salt baked composition or; leaching Li+, one or more types of non-lithium cations, and SO42− from the acid baked or salt baked composition with water, thereby producing an acidic leachate including dissolved Li+, one or more types of non-lithium cations, and SO42−; adding a basic reagent to the acidic leachate in one or more steps to precipitate salts of one or more non-lithium cation(s) and produce one or more solid leachate tailings and a lithium-enriched liquor including dissolved Li+ and SO42−; and separating the lithium-enriched liquor from all of the one or more solid leachate tailing(s), thereby producing a product liquor including dissolved Li2SO4.

In some aspects, the techniques described herein relate to a method, including: contacting the product liquor with a precipitation agent in order to precipitate Li2CO3 or LiOH and produce a lithium-depleted aqueous phase and product lithium including the precipitated Li2CO3 or LiOH; and separating the product lithium from the lithium-depleted aqueous phase.

In some aspects, the techniques described herein relate to a method, wherein β-spodumene is acid baked with the electrochemical scrap waste or black mass containing LiFePO4.

In some aspects, the techniques described herein relate to a method, wherein the electrochemical scrap waste or black mass containing LiFePO4 or LiMnxFe(1-x)PO4 is decrepitated at a temperature of about 800° C. to about 1500° C.

In some aspects, the techniques described herein relate to a method, wherein the water leaching step performed at about 25 to about 70° C. and for a duration of 6 hours or less.

In some aspects, the techniques described herein relate to a method, wherein the electrochemical scrap waste or black mass containing LiFePO4 or LiMnxFe(1-x)PO4 is decrepitated with α-spodumene, thereby transforming the α-spodumene to β-spodumene.

In some aspects, the techniques described herein relate to a method, wherein the α-spodumene is in the form of floated alpha spodumene concentrate.

In some aspects, the techniques described herein relate to a method, wherein β-spodumene is also acid baked or salt baked with the electrochemical scrap waste or black mass containing LiFePO4 or LiMnxFe(1-x)PO4.

In some aspects, the techniques described herein relate to a method, including adding a basic reagent to the acidic leachate by: raising a pH of the acidic leachate, with an addition of a basic reagent, to a first predetermined value at which one or more non-lithium salts are precipitated therefrom and at which Li2SO4 remains solvated therein; separating precipitated non-lithium salt(s) from the acid leachate containing the solvated Li2SO4; and raising a pH of the acidic leachate to a second predetermined value higher than said first predetermined value, with an addition of a basic reagent, at which Li2SO4 precipitates therefrom.

In some aspects, the techniques described herein relate to a method, wherein the precipitation agent is CO2, Na2CO3, and/or K2CO3 in order to precipitate Li2CO3.

In some aspects, the techniques described herein relate to a method, wherein the precipitation agent is NaOH, Ca(OH)2, and/or KOH in order to precipitate LiOH.

In some aspects, the techniques described herein relate to a method, wherein the electrochemical scrap waste or black mass contains 1-20 wt % lithium.

In some aspects, the techniques described herein relate to a method, wherein the electrochemical scrap waste or black mass contains 1-10 wt % lithium.

In some aspects, the techniques described herein relate to a method, wherein the electrochemical scrap waste or black mass contains includes 1-5 wt % lithium.

In some aspects, the techniques described herein relate to a method, wherein the electrochemical scrap waste or black mass contains includes 2-3.5 wt % lithium.

In some aspects, the techniques described herein relate to a method, wherein the electrochemical scrap waste or black mass contains 2.6-2.8 wt % lithium.

In some aspects, the techniques described herein relate to a method, wherein the acid baking is performed in an acid baking vessel chosen from rotary kilns, Waelz kilns, industrial ovens, industrial muffle furnaces, roasting furnaces, and combinations thereof.

In some aspects, the techniques described herein relate to a method, wherein the acid baking vessel is a rotary kiln or Waelz kiln and the acid baking is performed with gaseous oxidant such as air, oxygen-enriched air or industrially pure oxygen is injected into an interior thereof.

In some aspects, the techniques described herein relate to a method, wherein the electrochemical scrap waste or black mass contains LiFePO4 or LiMnxFe(1-x)PO4 and is decrepitated in a decrepitation vessel with α-spodumene, thereby transforming the α-spodumene to β-spodumene, and the decrepitation vessel is chosen from rotary kilns, Waelz kilns, industrial ovens, industrial muffle furnaces, and roasting furnaces.

In some aspects, the techniques described herein relate to a method, wherein the lithium is extracted in an amount of at least about 54 wt. %.

In some aspects, the techniques described herein relate to a method, wherein a weight ratio of electrochemical scrap waste or black mass containing LiFePO4 or LiMnxFe(1-x)PO4 to β-spodumene is about 90:10 to about 10:90.

### DRAWINGS

For a further understanding of the nature and objects of the present disclosure, reference is made to the following detailed description, taken in conjunction with the accompanying drawings, in which like elements are given the same or analogous reference numbers and wherein:

FIG. 1 is a flow chart according to one aspect of the disclosure.

FIG. 2 is a flow chart according to a second aspect of the disclosure including acid baking of β-spodumene.

FIG. 3 is a flow chart according to a third aspect of the disclosure including precipitation and separation of lithium product from lithium-depleted acidic leachate.

FIG. 4 is a flow chart according to a fourth aspect of the disclosure including acid baking of β-spodumene.

FIG. 5 is a flow chart according to another aspect of the disclosure.

FIG. 6 is a flow chart according to an aspect of the disclosure including acid baking of β-spodumene.

FIG. 7 is a flow chart according to an aspect of the disclosure including decrepitation of α-spodumene.

FIG. 8 is a flow chart according to an aspect of the disclosure including precipitation and separation of lithium product from lithium-depleted acidic leachate.

FIG. 9 is a flow chart according to an aspect of the disclosure including acid baking of β-spodumene.

FIG. 10 is a flow chart according to an aspect of the disclosure including decrepitation of α-spodumene.

FIG. 11A is a graph of the recovery performance of certain materials produced according to an aspect of the disclosure.

FIG. 11B is a graph of the recovery performance of certain materials produced according to an aspect of the disclosure.

FIG. 11C is a graph of the recovery performance of certain materials produced according to an aspect of the disclosure.

FIG. 12A is a graph of the recovery performance of certain materials produced according to an aspect of the disclosure.

FIG. 12B is a graph of the recovery performance of certain materials produced according to an aspect of the disclosure.

FIG. 12C is a graph of the recovery performance of certain materials produced according to an aspect of the disclosure.

### DETAILED DESCRIPTION

Disclosed herein are novel methods for recovering lithium from a material comprising LiFePO₄ (also referred to as LFP) or similar battery chemistries including LiMnₓFe₍₁₋ₓ₎PO₄ (also referred to as LMFP), wherein the material includes one or more of a LiFePO₄ or LiMnₓFe₍₁₋ₓ₎PO₄ containing black mass, LiFePO₄ or LiMnₓFe₍₁₋ₓ₎PO₄ that is derived from LiFePO₄ or LiMnₓFe₍₁₋ₓ₎PO₄ containing black mass, α-spodumene, or β-spodumene. In some embodiments, the method can include the steps of acid baking the material comprising LiFePO₄ or LiMnₓFe₍₁₋ₓ₎PO₄ to produce an acid baked composition, leaching Li⁺, one or more types of non-lithium cations, and SO₄²⁻ from the acid baked composition with water to produce an acidic leachate, adding a basic reagent to the acidic leachate in one or more steps in order to precipitate salts of the non-lithium cations, separating the lithium-enriched liquor from the one or more solid leachate tailings comprising the precipitated salt(s) of the one or more non-lithium cations to produce a product liquor, and contacting the product liquor with carbon dioxide, one or more carbonates, and/or one or more hydroxides in order to precipitate product Li₂CO₃ or LiOH after separation from the lithium-depleted aqueous phase.

In some aspects, the LiFePO₄ or LiMnₓFe₍₁₋ₓ₎PO₄ containing black mass can be obtained by a multistep process. Electrochemical scrap waste containing LiFePO₄ or LiMnₓFe₍₁₋ₓ₎PO₄ may still contain an electrical charge from the electronic device that the battery or electrochemical cell was installed in. In order to avoid fires that might result from directly shredding such devices, they may first be discharged in a controlled manner and subsequently shredded. Alternatively, the devices may be shredded in an inert atmosphere to thereby form the electrochemical scrap waste. In order to concentrate the LiFePO₄ or LiMnₓFe₍₁₋ₓ₎ PO₄ content of the electrochemical scrap waste, any of one or more separation steps may be carried out. A magnet may also be used to remove magnetized portions of the waste, such as steel casings. Other portions of the waste may be separated out on the basis of density using a device such as a hydrocyclone. Further, electrolyte may either be removed by washing with a suitable solvent or by volatilizing it in a relatively hot (e.g., 180° C.) inert atmosphere (such as nitrogen). Also, binders and plastics (such as polyvinylidene fluoride) may be removed through pyrolysis at a suitable temperature (e.g., ˜500° C.). These processing steps yield a relatively small particle size fraction enriched in LiFePO₄ or LiMnₓFe₍₁₋ₓ₎PO₄. In addition to LiFePO₄ or LiMnₓFe₍₁₋ₓ₎PO₄, the black mass might also include: other lithium metal oxides; graphite; organics such as alkyl carbonates; plastics such as polyvinylidene fluoride; and iron, aluminum, copper, cobalt, nickel, and/or manganese metals, alloys, and/or compounds. Typically, the elemental composition of the LFP or LMFP black mass includes: 20-70 wt % carbon, 0.2-2.0 wt % cobalt, 1-12 wt % copper, 1-25 wt % iron, 0.1-3.0 wt % manganese, 1-5 wt % nickel, 0.01-0.5 wt % zinc, 1-13 wt % aluminum, 0.05-0.20 wt % magnesium, 0.00-0.01 wt % cadmium, 2-8 wt % lithium, 0.0-0.5 wt % lead, 2-5 wt % fluorine, 0.05-1.00 wt % calcium, 0.01-0.10 wt % potassium, and 5-25 wt % phosphorus.

The material comprising LiFePO₄ or LiMnₓFe₍₁₋ₓ₎PO₄ or β-spodumene that is acid baked or salt baked in accordance with the methods of the disclosure (as described below) is either the LiFePO₄ or LiMnₓFe₍₁₋ₓ₎PO₄-containing black mass or it is LiFePO₄ or LiMnₓFe₍₁₋ₓ₎PO₄ that is derived from LiFePO₄ or LiMnₓFe₍₁₋ₓ₎PO₄-containing black mass. When the LiFePO₄ or LiMnₓFe₍₁₋ₓ₎PO₄-containing material is LiFePO₄ or LiMnₓFe₍₁₋ₓ₎PO₄-containing black mass, it may be acid baked without decrepitation of the black mass beforehand. In contrast, when the LiFePO₄ or LiMnₓFe₍₁₋ₓ₎PO₄-containing material is LiFePO₄ or LiMnₓFe₍₁₋ₓ₎PO₄ derived from LiFePO₄ or LiMnₓFe₍₁₋ₓ₎PO₄-containing black mass, acid baking or salt baking is performed after decrepitation of the LiFePO₄ or LiMnₓFe₍₁₋ₓ₎PO₄-containing black mass.

Those skilled in the art will recognize that decrepitation involves the thermal processing of a solid in a vessel (such as a furnace or kiln, especially a rotary kiln) for allowing relatively high temperature gas-solid reactions between the kiln atmosphere and the solid being decrepitated. Decrepitation of the LiFePO₄ or LiMnₓFe₍₁₋ₓ₎PO₄-containing black mass results in shattering of the LiFePO₄ or LiMnₓFe₍₁₋ₓ₎PO₄crystals, thereby increasing the surface area available for subsequent chemical processing of the decrepitated black mass. Decrepitation of the LiFePO₄ or LiMnₓFe₍₁₋ₓ₎PO₄-containing black mass is advantageous because the amount of energy released by combustion of the graphite content in the black mass allows the amount of fuel needed for thermally processing the black mass to be correspondingly decreased. It is also advantageous, because in some instances it may be useful to utilize the graphite content in the black mass as a reductant. Typically, the decrepitation is carried out at a temperature of about 800° C. to about 1500° C., and more typically about 800° C. to about 1200° C. In some aspects, decrepitation is performed at about 800° C., about 850° C., about 900° C., about 950° C., about 1000° C., about 1200° C., about 1250° C., about 1300° C., about 1350° C., about 1400° C., about 1450° C., or about 1500° C., or any range of temperature made of at least one of the preceding values.

One particular rotary kiln suitable for decrepitation of the LiFePO₄ or LiMnₓFe₍₁₋ₓ₎PO₄-containing black mass is a Waelz kiln. Waelz kilns were originally developed for the recovery of zinc from zinc compounds that included combusting or heating a carbon-containing fuel/reductant in the kiln to first reduce the zinc present to zinc metal, followed by volatilization of the zinc metal, and oxidation of the volatilized zinc metal in an oxygen-containing atmosphere to produce solid zinc oxides. Waelz kilns are typically several tens of meters (for example, 55 m) long with a diameter measuring several meters (for example, 4 m) and slightly inclined (for example, about 2-3%). Waelz kilns are ordinarily designed to be operated with a relatively low rotational speed (for example, 1 rpm). They are configured as a counter-current device in which the flow of solids travels from the lower end towards the higher end while the kiln gases flow in the opposite direction. Although the disclosure describes Waelz kilns, it is appreciated that the exact form and construction of the kiln is not limited.

Optionally and in some aspects of the disclosure, the LiFePO₄ or LiMnₓFe₍₁₋ₓ₎PO₄-containing black mass may be decrepitated along with spodumene (LiAl(SiO₃)₂) in its alpha crystalline phase (that is, α-spodumene). The α-spodumene is typically mined concentrate that has been ground and crushed (comminution) to reach the desired particle size and then subjected to a series of physical separation/mineral processing steps, such as flotation and dense media separation, to obtain a floated alpha spodumene concentrate which contains ˜5.5-6.5 wt % Li₂O (˜2.6-2.8% lithium). During thermal processing, the monoclinic crystalline structure of the is transformed into the more open, tetragonal crystalline structure of β-spodumene. The change in density from α-spodumene to β-spodumene results in friable spodumene particles with a much higher surface area on a same weight basis. When the LiFePO₄ or LiMnₓFe₍₁₋ₓ₎PO₄-containing black mass is decrepitated with α-spodumene, the wt:wt ratio of the α-spodumene mass to the LiFePO₄ or LiMnₓFe₍₁₋ₓ₎PO₄-containing black mass typically ranges from 95:5 to 5:95. Decrepitation is performed because, while the α-spodumene is highly resistant to hot acidic attack (such as during acid baking), β-spodumene does not exhibit that same resistance.

Decrepitation of the LiFePO₄ or LiMnₓFe₍₁₋ₓ₎PO₄-containing black mass with the α-spodumene is advantageous because recovery of lithium in accordance with the disclosure does not necessarily require a new processing installation to be built for performing processes described herein. Rather, an already existing installation for recovering lithium from α-spodumene may be used for recovery of lithium. The configuration of such an installation avoids the need to make significant capital expenditure to build a new facility to accommodate the methods described herein. It is furthermore advantageous when processed at an existing installation (for example, for recovering lithium from α-spodumene) that would not be operating at full capacity prior to co-treating electrochemical scrap waste that contains LiFePO₄ or LiMnₓFe₍₁₋ₓ₎PO₄ (for example, black mass).

Following thermal treatment, the treated material comprising LiFePO₄ or LiMnₓFe₍₁₋ₓ₎PO₄ is cooled and optionally subjected to grinding or ball milling in order to break down any agglomerates resulting from the thermal treatment to a particle size distribution that is suitable for acid baking or salt baking.

In several aspects of the disclosure, whether the material comprising LiFePO₄ or LiMnₓFe₍₁₋ₓ₎PO₄ is LiFePO₄ or LiMnₓFe₍₁₋ₓ₎PO₄-containing black mass or is LiFePO₄ or LiMnₓFe₍₁₋ₓ₎PO₄ derived from decrepitation of LiFePO₄ or LiMnₓFe₍₁₋ₓ₎PO₄-containing black mass (with or without α-spodumene or β-spodumene), the material comprising LiFePO₄ or LiMnₓFe₍₁₋ₓ₎PO₄ is mixed with sulfuric acid and acid baked at an elevated temperature of 150-350° C. or salt baked at 150-1000° C. In order to better ensure that a desired amount of the lithium is sulfated, one of ordinary skill in the art will recognize that the concentration and volume of sulfuric acid may be determined in relation to mass of the material comprising LiFePO₄ or LiMnₓFe₍₁₋ₓ₎PO₄. The temperature at which acid baking or salt baking is performed will have an effect upon how much lithium is ultimately leached during the below-described water leaching step as well as upon how much iron is similarly leached. Relatively lower temperatures are advantageous in that relatively less iron is sulfated and ultimately leached during the water leaching step. At the same time, such temperatures may similarly decrease how much lithium is sulfated and leached. On the other hand, relatively higher temperatures are advantageous because they will increase the sulfation and leaching of lithium. At the same time, however, they will similarly tend to increase sulfation and leaching of iron. Therefore, depending upon which ultimate goals are sought, selection of an appropriate acid baking or salt baking temperature can sometimes be important.

Within the afore-mentioned range of 150-350° C. are included sub-ranges that extend from a lower end of a temperature sub-range to an upper end of a temperature sub-range, including all permutations of the following lower ends of a temperature sub-range and upper ends of a temperature sub-range.

For example, acid baking can be performed within a range of temperatures that include a lower end thereof and an upper end thereof, wherein the lower end is selected from about 350° C., about 340° C., about 330° C., about 320° C., about 310° C., about 300° C., about 290° C., about 280° C., about 270° C., about 260° C., about 250° C., about 240° C., about 230° C., about 220° C., about 210° C., about 200° C., about 190° C., about 180° C., about 170° C., about 160° C., and about 150° C. and the upper end is selected from about 350° C., about 340° C., about 330° C., about 320° C., about 310° C., about 300° C., about 290° C., about 280° C., about 270° C., about 260° C., about 250° C., about 240° C., about 230° C., about 220° C., about 210° C., about 200° C., about 190° C., about 180° C., about 170° C., and about 160° C. One range of temperatures for the acid baking can be from about 150° C. to about 350° C.

In other embodiments, the material comprising LiFePO₄ or LiMnₓFe₍₁₋ₓ₎PO₄ can be salt baked by contacting it with a sulfur containing salt such as sodium sulfate or sodium bisulfate in a range of temperatures of about 150° C. to about 1000° C. The salt baking range of temperatures includes a lower end thereof and an upper end thereof, wherein the lower end is selected from about 1000° C., about 950° C., about 900° C., about 850° C., about 800° C., about 790° C., about 780° C., about 770° C., about 760° C., about 750° C., about 740° C., about 730° C., about 720° C., about 710° C., about 700° C., about 690° C., about 680° C., about 670° C., about 660° C., about 650° C., about 640° C., about 630° C., about 620° C., about 610° C., about 600° C., about 590° C., about 580° C., about 570° C., about 560° C., about 550° C., about 540° C., about 530° C., about 520° C., about 510° C., about 500° C., about 490° C., about 480° C., about 470° C., about 460° C., about 450° C., about 440° C., about 430° C., about 420° C., about 410° C., about 400° C., about 390° C., about 380° C., about 370° C., about 360° C., about 350° C., about 340° C., about 330° C., about 320° C., about 310° C., about 300° C., about 290° C., about 280° C., about 270° C., about 260° C., about 250° C., about 240° C., about 230° C., about 220° C., about 210° C., about 200° C., about 190° C., about 180° C., about 170° C., about 160° C., and about 150° C. and the upper end is selected from about 1000° C., about 950° C., about 900° C., about 850° C., about 800° C., about 800° C., about 790° C., about 780° C., about 770° C., about 760° C., about 750° C., about 740° C., about 730° C., about 720° C., about 710° C., about 700° C., about 690° C., about 680° C., about 670° C., about 660° C., about 650° C., about 640° C., about 630° C., about 620° C., about 610° C., about 600° C., about 590° C., about 580° C., about 570° C., about 560° C., about 550° C., about 540° C., about 530° C., about 520° C., about 510° C., about 500° C., about 490° C., about 480° C., about 470° C., about 460° C., about 450° C., about 440° C., about 430° C., about 420° C., about 410° C., about 400° C., about 390° C., about 380° C., about 370° C., about 360° C., about 350° C., about 340° C., about 330° C., about 320° C., about 310° C., about 300° C., about 290° C., about 280° C., about 270° C., about 260° C., about 250° C., about 240° C., about 230° C., about 220° C., about 210° C., about 200° C., about 190° C., about 180° C., about 170° C., and about 160° C. One range of temperatures for the salt baking can be from about 150° C. to about 1000° C.

One of ordinary skill in the art will recognize that the permutations of temperature sub-ranges only include those in which the lower end constitutes a temperature which is lower than the upper end. For example, the permutations do not include a paired lower end of 690° C. and upper end of 680° C. but do include a paired lower end of 680° C. and upper end of 690° C.

The baking is performed in a vessel (such as a furnace or kiln, especially a rotary kiln) that is either heated through combustion of fuel and an oxidant in an interior of the vessel or is electrically heated. Again, one particular rotary kiln suitable for the acid baking step is a Waelz kiln.

Optionally, other sulfating agents may be used in addition to the sulfuric acid, such as Na₂SO₄, Fe₂SO₃, NaHSO₄, or CaSO₄. The use of such additional sulfating agents is advantageous because, to the extent that they are used for acid baking with the sulfuric acid, they tend to decrease the amount of iron, and to some degree perhaps even phosphate, that winds up being leached from the acid baked composition in the water leaching step described below. At the same time, because the above-mentioned sulfating agents also contain sodium, iron, or calcium that may also tend to be leached away during the water leaching step, the use of such additional sulfating agents should be limited. Otherwise, such additional amounts of sodium, iron, or calcium in the acidic leachate will need to be removed therefrom prior to production of the desired lithium product. Towards this end, the use of sodium bisulfate as an additional sulfating agent may be advantageous in comparison to the use of sodium sulfate because, for a same molar amount of SO₄²⁻, sodium bisulfate contains half the amount of sodium as sodium sulfate. Regardless of which additional sulfating agent is used, if at all, typically, the mol:mol ratio of sulfuric acid to additional sulfating agent ranges from 0.05:1 to 20:1.

Optionally, an oxidizing agent may also be utilized within the acid baking vessel to oxidize Fe²⁺ to Fe³⁺. Typical oxidants for admixture with the material comprising LiFePO₄ or LiMnₓFe₍₁₋ₓ₎PO₄ during acid baking include but are not limited to potassium permanganate, potassium dichromate, sodium nitrate, potassium nitrate, ferric sulfate, and liquid hydrogen peroxide. A gaseous oxidant may instead be used in the atmosphere within the acid baking vessel to similarly oxidize Fe²⁺ to Fe³⁺. Typically gaseous oxidants include but are not limited to air, industrially pure oxygen, and oxygen-enriched air. Because Fe³⁺ is relatively more insoluble in water than Fe²⁺, oxidation of at least some of the Fe²⁺ to Fe³⁺ results in less iron being leached during the water-leaching step following acid baking. Less leached iron means that less basic reagent is needed for precipitation of the iron cations as an iron salt. When a rotary kiln (such as a Waelz kiln) is selected for use as the acid baking vessel, a gaseous oxidant may be injected into an interior of the rotary kiln and be combusted therein with the fuel used to provide the necessary heat for acid baking. For example, a stoichiometric excess of oxidant may be used to fully combust the fuel and also provide an oxidizing atmosphere.

During acid baking, the sulfuric acid attacks the decrepitated LiFePO₄ or LiMnₓFe₍₁₋ₓ₎PO₄ and much of the lithium content is sulfated as protons from the sulfuric acid replace lithium cations in the LiFePO₄ or LiMnₓFe₍₁₋ₓ₎PO₄crystalline structure. To some degree, some of the iron content may potentially also be sulfated as protons and replace some of the iron cations in the LiFePO₄ or LiMnₓFe₍₁₋ₓ₎PO₄molecules, leaving some of the iron in phosphate form. Amounts of other cations (that may originally be present in the form of oxides in the LiFePO₄ or LiMnₓFe₍₁₋ₓ₎PO₄-containing black mass prior to acid baking) may also potentially be similarly sulfated including iron, aluminum, magnesium, boron, and/or calcium. Completion of the acid baking step yields an acid baked composition.

Next, the acid baked composition is leached with water, typically at a temperature of 0-100° C., more typically 25-70° C., in order to extract the lithium and sulfate therefrom to produce an acidic leachate that contains the extracted Li⁺ and SO₄²⁻. Because it is obtained from the acid baked composition, the acidic leachate typically has a pH of 1-6. As mentioned above, the acidic leachate may potentially also include dissolved Fe³⁺ and Fe²⁺. Depending upon the elemental composition of the LiFePO₄ or LiMnₓFe₍₁₋ₓ₎PO₄-containing black mass and as mentioned above, the acidic leachate may also include dissolved copper, aluminum, magnesium, calcium, boron, silicon, sodium, and/or potassium. Typically, the acid leaching step is carried out for a duration of 6 hrs or less.

One advantage of decrepitating LiFePO₄ or LiMnₓFe₍₁₋ₓ₎PO₄-containing black mass in a rotary kiln (such as a Waelz kiln), with or without α-spodumene, is to make use of the carbon content of the LiFePO₄ or LiMnₓFe₍₁₋ₓ₎PO₄-containing black mass as a reductant/heat source. If the carbon content is not used in such a manner, it will end up as waste in the residue remaining after the lithium is leached out of the acid baked composition.

In order to separate the non-lithium cations from the lithium cations, the acidic leachate can be subjected to one or more purification steps that include adding a basic reagent to the acidic leachate to precipitate one or more salts of the non-lithium cation(s) in the form of a solid tailing and separating the resultant lithium-enriched liquor from the solid tailing(s). This may be performed with any technique known in the field of hydrometallurgy. NaOH, KOH, CaO (e.g., lime), and Ca(OH)₂ are non-limiting examples of suitable basic reagents.

In one non-limiting example, iron can be precipitated as Fe(OH)₃, magnesium is precipitated as Mg(OH)₂, aluminum is precipitated as Al(OH)₃, and boron is precipitated as B(OH)₃. While a non-lithium content may be precipitated out in a single step, it is also contemplated in the disclosure to recover one or more of the non-lithium constituents in one or more separate basic reagent addition steps. In another non-limiting example, iron and aluminum are first precipitated through a first addition of a basic reagent to the acidic leachate and calcium (if present) and magnesium (if present) are next precipitated through a second addition of basic reagent to the acidic leachate. In yet another non-limiting example, such basic reagent addition steps may include adding a sufficient amount of the basic reagent to increase a pH of the acidic leachate to 3-4 in order to precipitate iron as Fe(OH)₃ and adding a sufficient amount of the basic reagent to further the pH to 5-6 in order to precipitate (and if desired, separately recover from the acidic leachate) aluminum as Al(OH)₃. The one or more solid tailings, resulting from the one or more steps of basic reagent addition, are then removed from the resultant supernatant (that is, the product liquor comprising Li₂SO₄). Optionally, the solid tailing(s), may be recovered in the form of a metal hydroxide precipitate (MHP) for processing according to any technique known in the field of metallurgy (such as smelting) to recover individual metals, such as nickel, cobalt, and/or copper.

Solid Li₂CO₃ product may be produced by contacting the product liquor with CO₂ (such as with a sparger) and/or one or more carbonates (in the form of a powder or slurry containing 10-30 wt % of the carbonate(s)) to precipitate Li₂CO₃. Suitable carbonates include Na₂CO₃ and K₂CO₃. In one non-limiting example, the product liquor may be first contacted with Na₂CO₃ and/or K₂CO₃ and subsequently contacted with CO₂ via a sparger. In a second non-limiting example, the product liquor may be contacted with only Na₂CO₃ and/or K₂CO₃ and not CO₂. The solid Li₂CO₃ product may be recovered by separating the precipitate from the resultant supernatant. This may be performed with any technique known in the field of hydrometallurgy. The solid Li₂CO₃ product may also be subjected to further purification steps.

Alternatively, solid LiOH product may be produced by contacting the product liquor with one or more hydroxides (in the form of a powder or a slurry containing 10-70 wt % of the hydroxide(s)) in order to precipitate LiOH. Suitable hydroxides include NaOH, KOH, and Ca(OH)₂. The solid LiOH product may be recovered by separating the precipitate from the resulting supernatant. This may be performed with any technique known in the field of hydrometallurgy. The solid LiOH product may also be subjected to further purification steps.

In some embodiments, the Li is extracted in an amount of at least about 54 wt. %, at least about 60 wt. %, at least about 65 wt. %, at least about 70 wt. %, at least about 75 wt. %, at least about 80 wt. %, at least about 85 wt. %, at least about 90 wt. %, or at least about 95 wt. %.

In some embodiments, the weight ratio of electrochemical scrap waste or black mass containing LiFePO₄ or LiMnₓFe₍₁₋ₓ₎PO₄ to β-spodumene is about 90:10 to about 10:90, about 15:85, about 20:80, about 25:75, about 30:70, about 35:65, about 40:60, about 45:55, about 50:50, about 55:45, about 60:40, about 65:35, about 70:30, about 75:25, about 80:20, about 85:15, or about 90:10.

Performance of the methods according to several aspects of the disclosure can be achieved in several different ways.

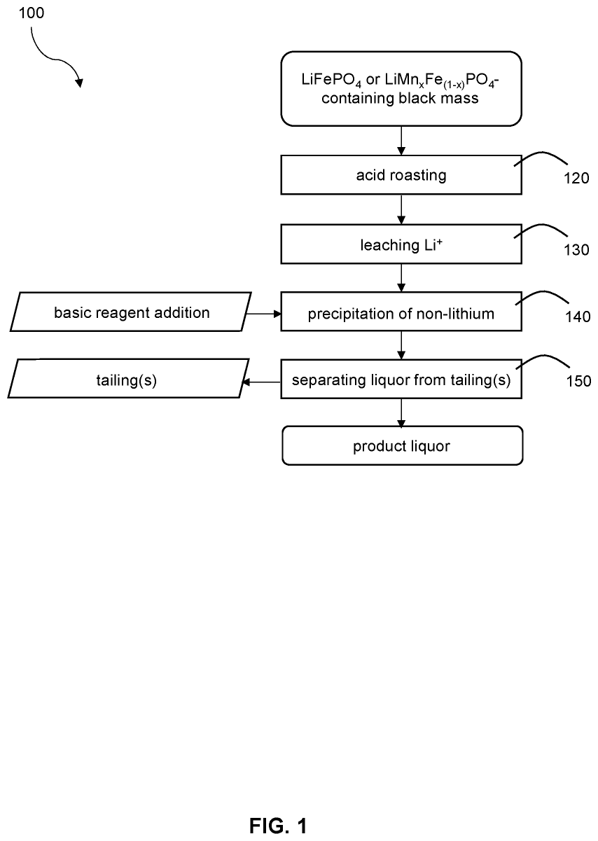

FIG. 1 shows a process 100 of recovering at least Li from electrochemical scrap waste that includes LiFePO₄ or LiMnₓFe₍₁₋ₓ₎PO₄-containing black mass without decrepitation beforehand. In process 100, LiFePO₄ or LiMnₓFe₍₁₋ₓ₎PO₄ is provided and acid baked 120 to produce an acid baked composition (not shown). The acid baked composition is leached with water in a step 130 to leach Li⁺ and SO₄²⁻ therefrom to produce an acidic leachate containing dissolved Li⁺ and SO₄²⁻. A basic reagent is added to the acidic leachate in a step 140 to precipitate salts of one or more non-lithium cations to produce one or more solid leachate tailings comprising the precipitated salt(s) of the non-lithium cation(s) and a lithium-enriched liquor comprising dissolved Li⁺ and SO₄²⁻. The lithium-enriched liquor is separated from the solid leachate tailing(s) in a step 150 to produce product liquor comprising dissolved Li⁺ and S0₄²⁻. The process steps of the paragraph are also generally described above and herein, including the acid baking (paragraphs [0082]-[0090]), leaching with water (paragraph [0091]), and precipitating salts of one or more non-lithium cations (paragraph [0094]).

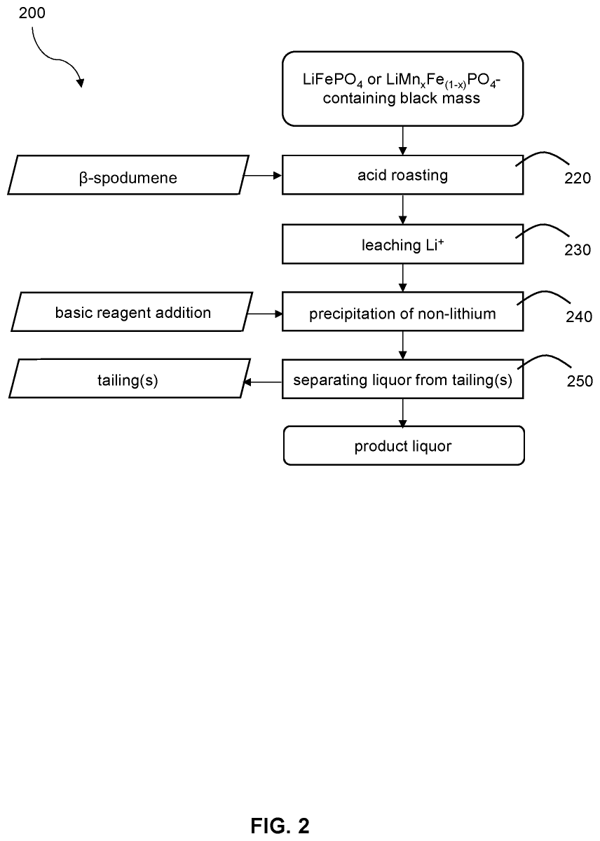

The process 200 of recovering at least Li of FIG. 2 can be the same as that of FIG. 1, except that β-spodumene is also acid baked with the LiFePO₄ or LiMnₓFe₍₁₋ₓ₎PO₄-containing black mass in step 220. Process 200 also can include leaching in water 230, adding basic reagent to precipitate salts 240. There is also step 250 which includes separating the liquor from the tailings.

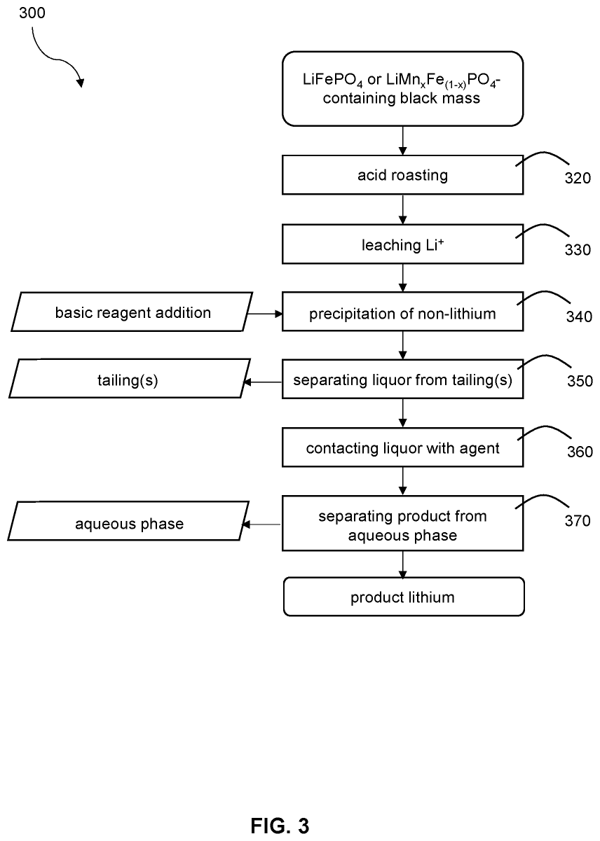

In some embodiments, the process 300 of FIG. 3 is the same as that of FIG. 1, except that the process also includes a step of contacting the product liquor with a precipitation agent in step 340 to precipitate product lithium comprising Li₂CO₃ or LiOH and also a lithium-depleted aqueous phase. The process of FIG. 3 also includes the step of separating the product lithium from the aqueous phase in a step 370.

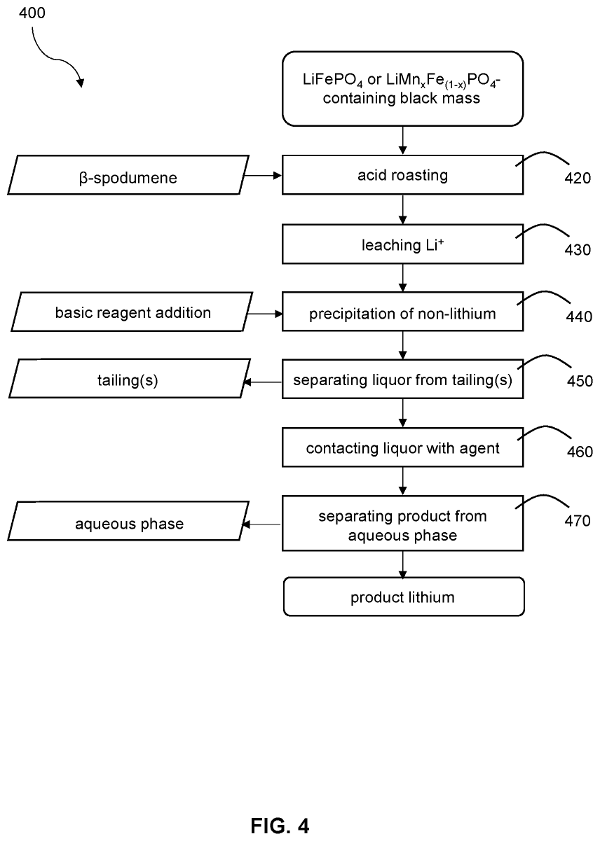

In some embodiments, the process of FIG. 4 is the same as that of FIG. 3, except that β-spodumene is also acid baked with the LiFePO₄ or LiMnₓFe₍₁₋ₓ₎PO₄-containing black mass in step 420.

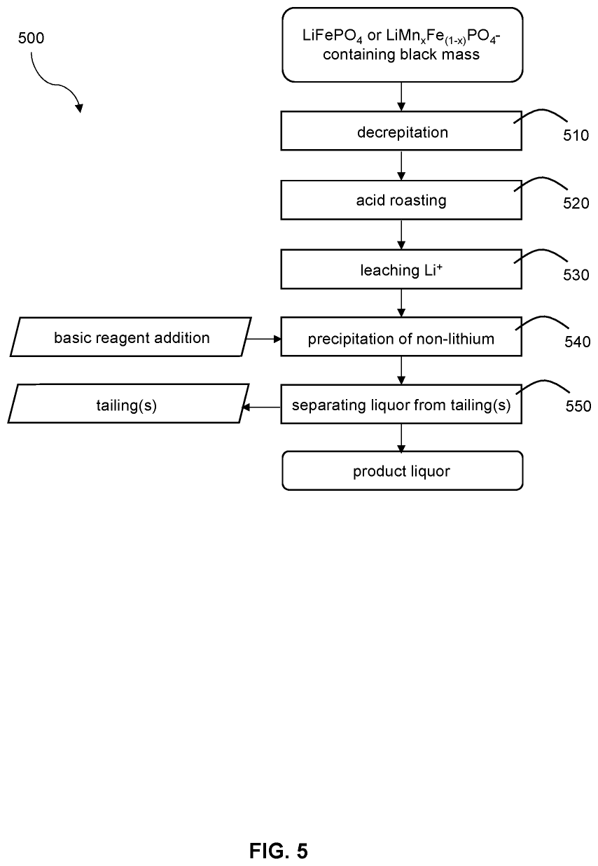

As shown in FIG. 5, LiFePO₄ or LiMnₓFe₍₁₋ₓ₎PO₄-containing black mass can be decrepitated in a step 510. The decrepitated LiFePO₄ or LiMnₓFe₍₁₋ₓ₎PO₄-containing black mass is acid baked 520 to produce an acid baked composition. The acid baked composition is leached with water 430 to leach Li⁺ and SO₄²⁻ therefrom to produce an acidic leachate containing dissolved Li⁺ and S0₄²⁻. A basic reagent is added to the acidic leachate in step 440 to precipitate salt(s) of one or more non-lithium cations to produce one or more solid leachate tailings comprising the precipitated salt(s) of the non-lithium cation(s) and a lithium-enriched liquor comprising dissolved Li⁺ and SO₄²⁻. The lithium-enriched liquor is separated from the solid leachate tailing(s) 450 to a produce product liquor comprising dissolved Li⁺ and S0₄²⁻. Similar to the above aspects of the disclosure, there are additional steps that include contacting the liquor with an agent 460 and separating that product from the aqueous phase 470.

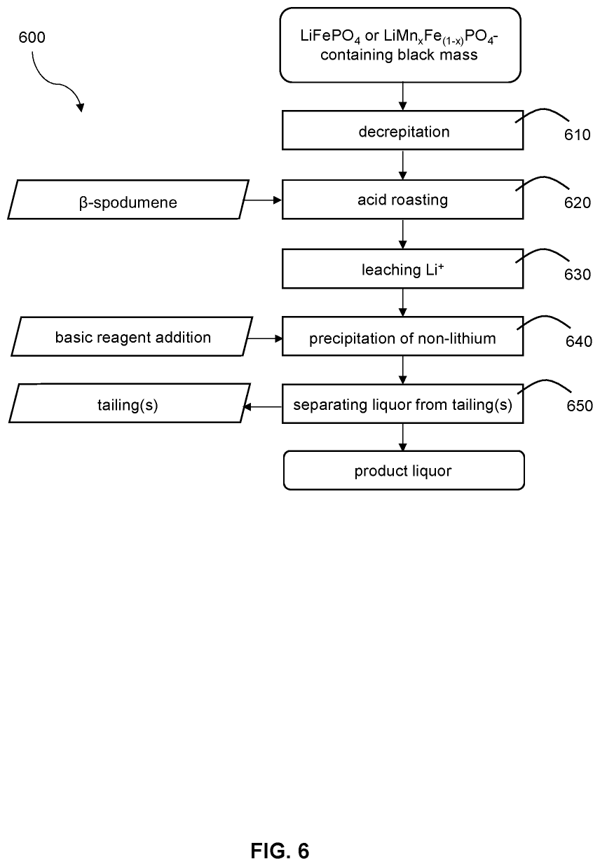

The process of FIG. 6 is the same as that of FIG. 5, except that β-spodumene is also acid baked with the LiFePO₄ or LiMnₓFe₍₁₋ₓ₎PO₄-containing black mass in step 620. Such an embodiment is an example where LiFePO₄ or LiMnₓFe₍₁₋ₓ₎PO₄-containing black mass is combined with ores containing Li which is refined to recover the Li.

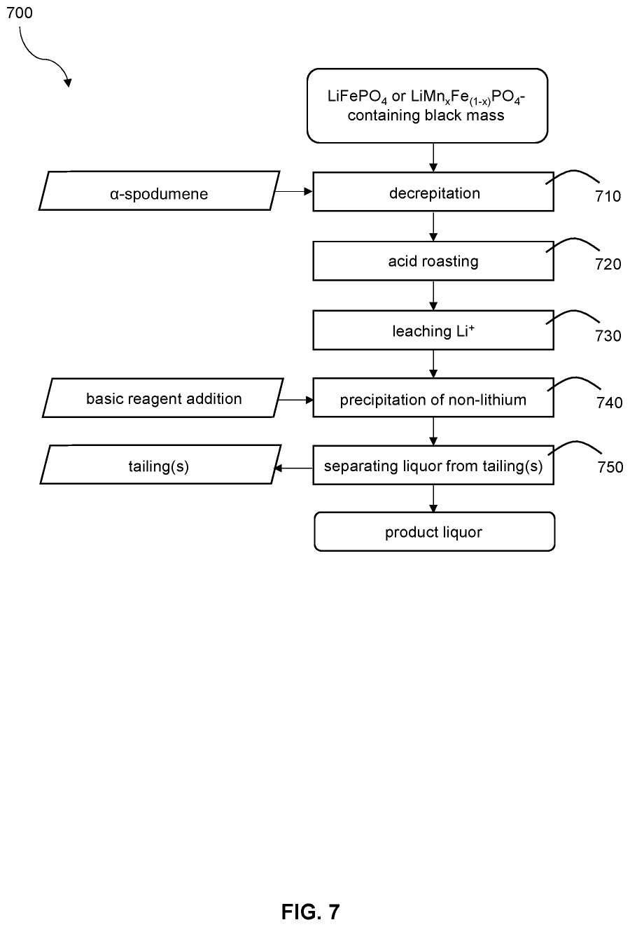

The process of FIG. 7 is the same as that of FIG. 5, except that α-spodumene is also decrepitated with the LiFePO₄ or LiMnₓFe₍₁₋ₓ₎PO₄-containing black mass in step 710. Decrepitation is beneficial because it shatters the LiFePO₄ or LiMnₓFe₍₁₋ₓ₎PO₄ crystals, thereby increasing the surface area available for subsequent chemical processing of the decrepitated black mass. Decrepitation of the LiFePO₄ or LiMnₓFe₍₁₋ₓ₎PO₄-containing black mass is advantageous because the amount of energy released by combustion of the graphite content in the black mass allows the amount of fuel needed for thermally processing the black mass to be correspondingly decreased. It is also advantageous, because in some instances it may be useful to utilize the graphite content in the black mass as a reductant. Typically, the decrepitation is carried out at a temperature of 800-1500° C., and more typically 800-1200° C. In some aspects, decrepitation is performed at about 800° C., about 850° C., about 900° C., about 950° C., about 1000° C., about 1200° C., about 1250° C., about 1300° C., about 1350° C., about 1400° C., about 1450° C., or about 1500° C., or any range of temperature made of at least one of the preceding values.

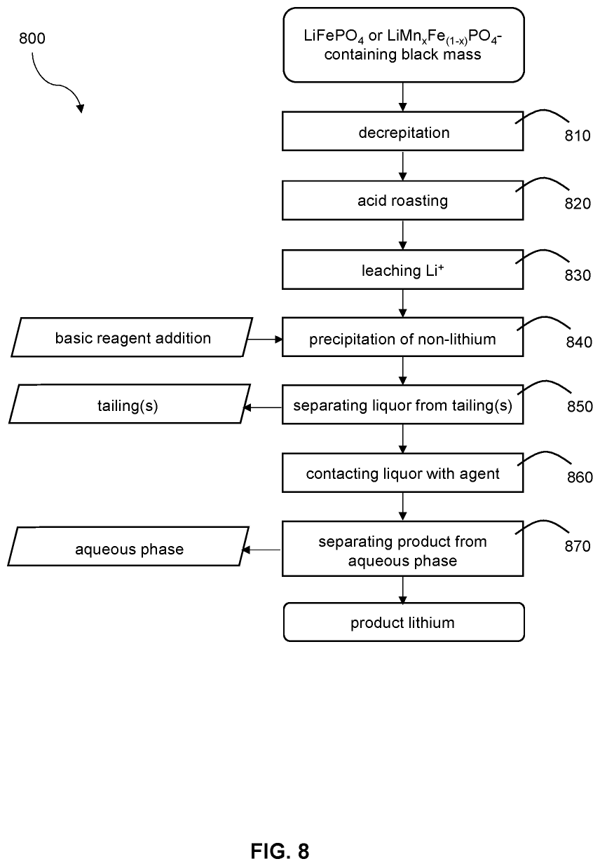

The process of FIG. 8 is the same as that of FIG. 5, except that the process includes a step of contacting the product liquor with a precipitation agent in step 160 to precipitate product lithium comprising Li₂CO₃ or LiOH and also a lithium-depleted aqueous phase. The process of FIG. 8 also includes the step of separating the product lithium from the aqueous phase in a step 170.

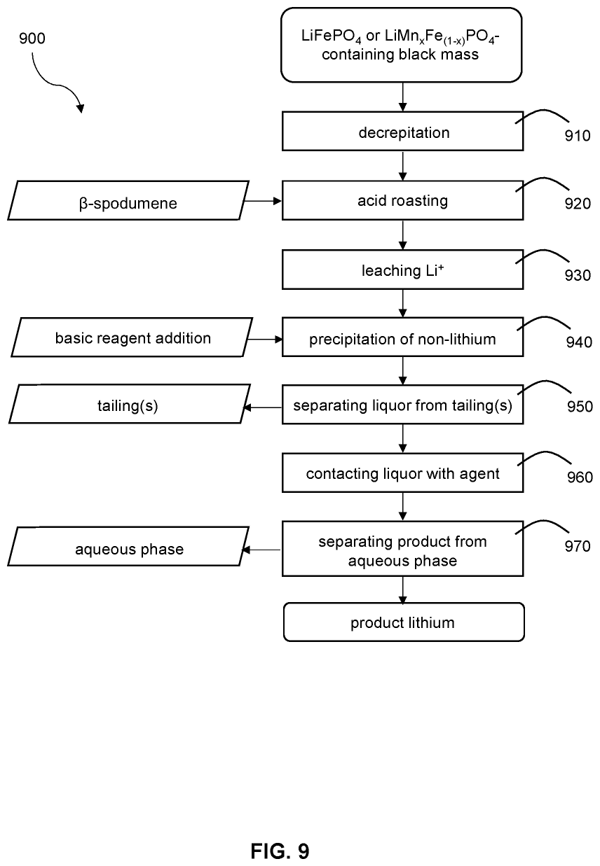

The process of FIG. 9 is the same as that of FIG. 8, except that β-spodumene is also acid baked with the LiFePO₄ or LiMnₓFe₍₁₋ₓ₎PO₄-containing black mass in step 820.

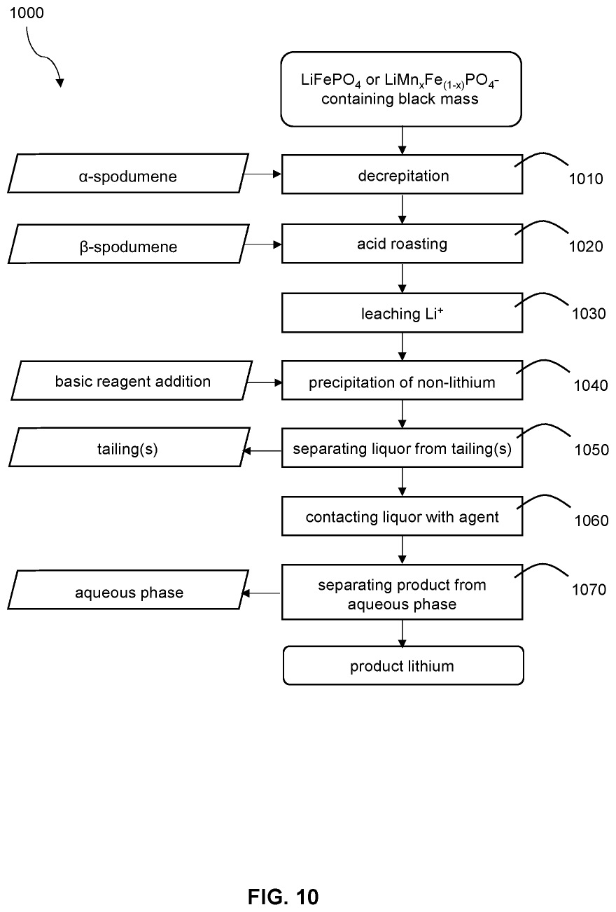

The process of FIG. 10 is the same as that of FIG. 8, except that α-spodumene is also decrepitated with the LiFePO₄ or LiMnₓFe₍₁₋ₓ₎PO₄-containing black mass in step 1010. As above, decrepitation is beneficial because it shatters the LiFePO₄ or LiMnₓFe₍₁₋ₓ₎PO₄ crystals, thereby increasing the surface area available for subsequent chemical processing of the decrepitated black mass and can utilize the graphite content as a reductant.

### EXAMPLES

LiFePO₄ black mass containing 2.09 wt. % lithium content was provided along with β-spodumene having 2.65 wt. % lithium content. The LiFePO₄ black mass is an example of electrochemical scrap waste that may be recovered from batteries or other electrochemical devices that have been recycled. The β-spodumene is an example of a typical grade β-spodumene mineral ore found in in various deposits around the world.

In the Examples, the LiFePO₄ black mass and β-spodumene were mixed in varying amounts, with amounts of β-spodumene varying from 0-200 g in each sample and the amount of LiFePO₄ black mass being included in amounts of 0-250 g. Examples 1-8 and 10 show the effects of processing only LiFePO₄ black matter, with no added β-spodumene. Example 11 shows the effect of processing only β-spodumene, with no added LiFePO₄ black matter. Finally, Examples 9 and 12-16 show the effect of processing various mixtures of LiFePO₄ black matter and β-spodumene.

The Examples also included tests of different compounds for roasting the black matter and the ore. In each of Examples 1-5, 8, 9, and 11-15 sulfuric acid (96% concentration) was mixed with the black mass and/or β-spodumene ore and roasted for 60 minutes. Each of Examples 6, 7, and 10 were instead mixed with a salt (sodium sulfate or sodium bisulfate) to permit higher experimental temperature and roasted for 240 minutes.

The LiFePO₄ black mass and the β-spodumene were provided alone or were uniformly mixed to form each of the Examples, of which the test conditions and experimental composition are shown in Table 1 below. After the LiFePO₄ black mass or the β-spodumene or both the LiFePO₄ black mass and the β-spodumene were provided, they were blended and while blending the 96% concentration sulfuric acid was added. After all of the sulfuric acid was added, the mixing continued for 10 minutes, after which the mixture was transferred to a tube furnace and held at the experimental temperature for the predetermined time (listed in Table 1—Experimental Setup below). The tube furnace rotated at about 6 rpm during the experiment. After completing the test, the heat is removed and the sample cooled to less than 100° C.

TABLE 1
Experimental Setup

| | | Acid | | |
|---|---|---|---|---|
| | | Concentration | β- | |
| | Temperature | (Stoichiometric | spodumene | LiFePO₄ |
| Example | (° C.) | Excess %) | weight (g) | Weight (g) |
| Ex. 1 | 200 | 40 | 0 | 250 |
| Ex. 2 | 300 | 40 | 0 | 200 |
| Ex. 3 | 300 | 80 | 0 | 200 |
| Ex. 4 | 200 | 80 | 0 | 200 |
| Ex. 5 | 200 | 100 | 0 | 200 |
| Ex. 6 | 550 | None (sodium | 0 | 150 |
| | | sulfate salt, | | |
| | | 83.4 g) | | |
| Ex. 7 | 550 | None (sodium | 0 | 150 |
| | | bisulfate salt, | | |
| | | 70.5 g) | | |
| Ex. 8 | 250 | 80 | 0 | 200 |
| Ex. 9 | 250 | 60 | 100 | 100 |
| Ex. 10 | 600 | None (sodium | 0 | 150 |
| | | bisulfate salt, | | |
| | | 100 g) | | |
| Ex. 11 | 250 | 35 | 200 | 0 |
| Ex. 12 | 250 | 80 | 100 | 100 |
| Ex. 13 | 250 | 100 | 100 | 100 |
| Ex. 14 | 250 | 50 | 160 | 40 |
| Ex. 15 | 250 | 35 | 160 | 40 |
| Ex. 16 | 250 | 35 | 180 | 20 |

After cooling and removal from the tube furnace, the sample was water leached. A 1 L glass leach vessel was provided and water was included. The sample from the furnace was mixed for 1 hour within the leach vessel under heating, after which the residue was removed and dried. The composition of the dried residue and leachate was analyzed to measure the amounts of lithium, iron, and phosphorous. The results of the extraction efficiencies of Li, Fe, P into leachate are shown in Table 2—Experimental Results (Extraction Efficiency) below.

TABLE 2
Experimental Results (Extraction Efficiency)

| | Extraction Efficiency in Leachate | | |
|---|---|---|---|
| Example | wt. % Li | wt. % Fe | wt. % P |
| Ex. 1 | 59 | 43 | 39 |
| Ex. 2 | 54 | 33 | 19 |
| Ex. 3 | 57 | 34 | 1 |
| Ex. 4 | 74 | 51 | 44 |
| Ex. 5 | 75 | 52 | 40 |
| Ex. 6 | 14 | 0 | 0 |
| Ex. 7 | 30 | 0 | 5 |
| Ex. 8 | 64 | 39 | 21 |
| Ex. 9 | 64 | 56 | 16 |
| Ex. 10 | 26 | 0 | 4 |
| Ex. 11 | 92 | 9 | 45 |
| Ex. 12 | 94 | 33 | 3 |
| Ex. 13 | 96 | 41 | 6 |
| Ex. 14 | 77 | 36 | 4 |
| Ex. 15 | 74 | 38 | 3 |
| Ex. 16 | 80 | 45 | 6 |

For certain Examples, the concentration of phosphorous in the leachate was measured and is shown in Table 3—Leachate P Concentration below.

TABLE 3
Leachate P Concentration

| | Extraction Efficiency in Leachate | | | P in leachate |
|---|---|---|---|---|
| Example | wt. % Li | wt. % Fe | wt. % P | (ppm) |
| Ex. 1 | 59 | 43 | 39 | 9000 |
| Ex. 11 | 92 | 9 | 45 | 200 |
| Ex. 12 | 94 | 33 | 3 | 200 |

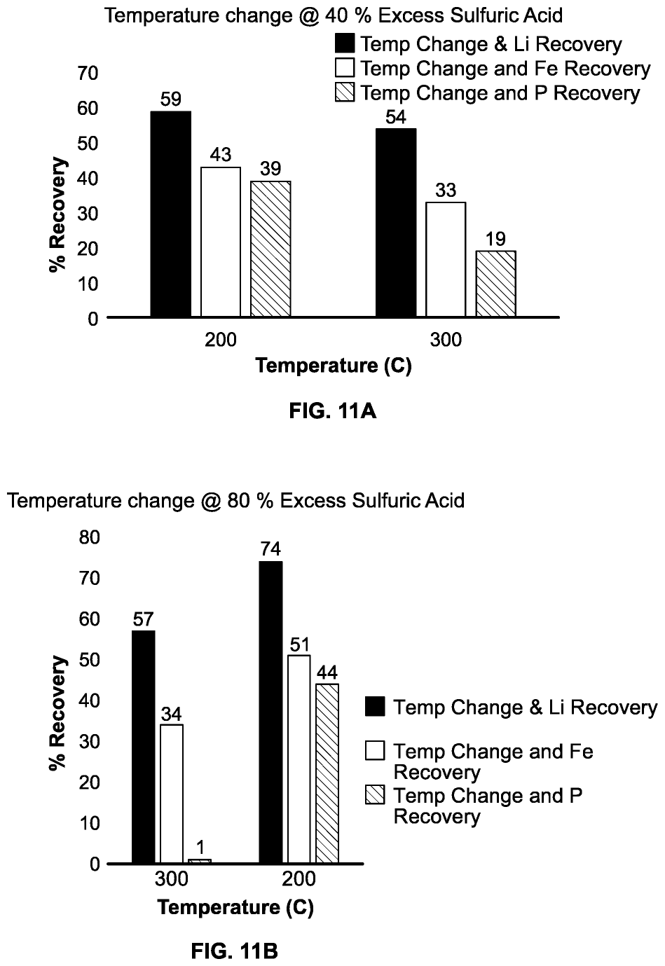

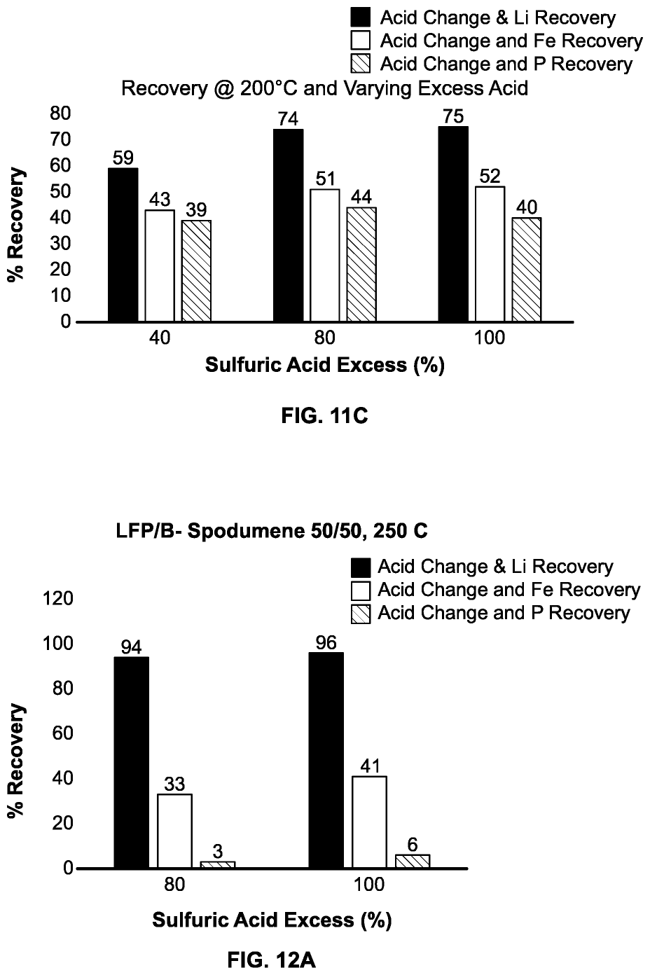

The experimental results were analyzed for the increase in recovery of Li, Fe, and P based on temperature. FIG. 11A shows a graph of the wt. % recovery of Li, Fe, and P at 200° C. and at 300° C. FIG. 11B shows a graph of effect of temperature change on the recovery of Li, Fe, and P when contacted with 80% excess sulfuric acid. FIG. 11C shows the effect on wt. % recovery of Li, Fe, and P based on changing the temperature and contacting with 80 wt. % excess sulfuric acid.

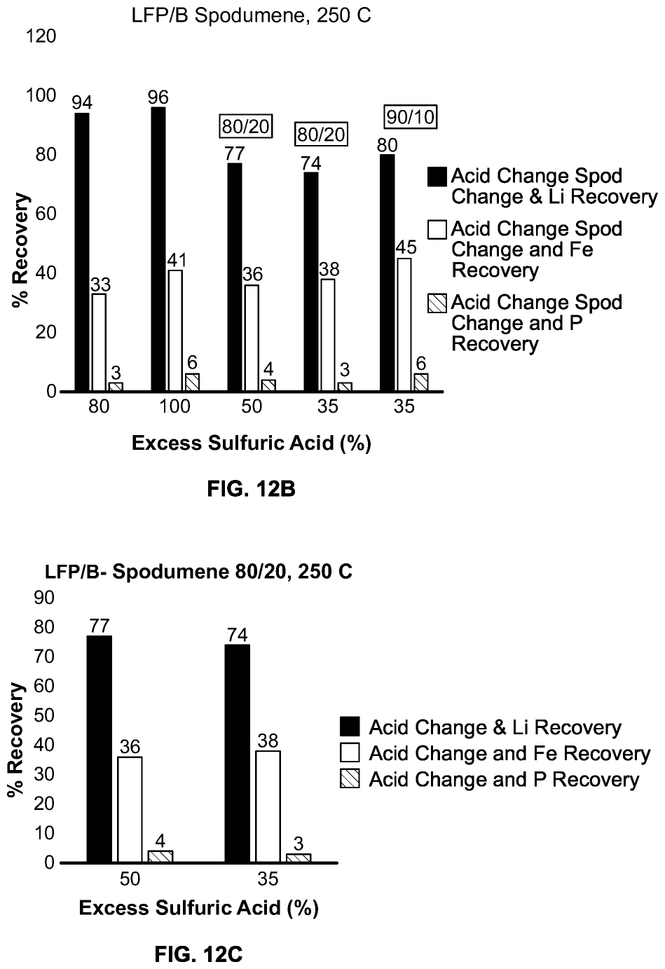

The experimental results also showed the effect of adding B-spodumene in differing amounts to the electrochemical scrap waste under various conditions. FIG. 12C shows a graph of the effect of excess sulfuric acid when applied in amounts of 100% or 80% to a sample containing LiFePO₄ and β-spodumene in a 50/50 ratio. FIG. 12B shows the results of recovering Li, Fe, and P from a combination of LiFePO₄ and β-spodumene at 250° C. when the amount of excess H₂SO₄ is altered. Several of the results also modify the ratios between LiFePO₄ and β-spodumene, again depicted in FIG. 12B. FIG. 12C shows the effect of the excess amount of sulfuric acid in the amounts of 50% and 35% when applied to a mixture of LiFePO₄ and β-spodumene.

Additional testing was also conducted to determine the Li extraction efficiency based on several experimental variables and is shown below in Table 4—Roasting Conditions and Results. It is noted that where the Li extraction states (“estimated”) that these values have been obtained based on preliminary experimental data pertaining to the residue.

TABLE 4
Roasting Conditions and Results

| | B- | | | | |
|---|---|---|---|---|---|
| | Spodu- | | | Temper- | |
| Exam- | mene | LiFePO₄ | Acid Excess | ature | Li Extraction |
| ple | (wt. %) | (wt. %) | % | (° C.) | (%) |
| Ex. 11 | 100 | 0 | 35 | 250 | 92 |
| Ex. 24 | 100 | 0 | 50 | 250 | 96 |
| Ex. 25 | 100 | 0 | 35 | 225 | — (Pending) |
| Ex. 6 | 0 | 100 | None (salt, | 550 | 14 (Na₂So₄:Li |
| | | | SO₄:Li = | | molar ratio) |
| | | | 1.3) | | |
| Ex. 7 | 0 | 100 | None (salt, | 550 | 30 (NaHSO₄:Li |
| | | | HSO₄:Li = | | molar ratio) |
| | | | 1.3) | | |
| Ex. 10 | 0 | 100 | None (salt, | 600 | 26 (NaHSO₄:Li |
| | | | HSO₄:Li = | | molar ratio) |
| | | | 1.8) | | |
| Ex. 1 | 0 | 100 | 40 | 200 | 59 |
| Ex. 2 | 0 | 100 | 40 | 300 | 54 |
| Ex. 3 | 0 | 100 | 80 | 300 | 57 |
| Ex. 4 | 0 | 100 | 80 | 200 | 74 |
| Ex. 5 | 0 | 100 | 100 | 200 | 75 |
| Ex. 8 | 0 | 100 | 80 | 250 | 64 |
| Ex. 9 | 50 | 50 | 60 | 250 | 64 |
| Ex. 12 | 50 | 50 | 80 | 250 | 94 |
| Ex. 13 | 50 | 50 | 100 | 250 | 96 |
| Ex. 14 | 80 | 20 | 50 | 250 | 77 |
| Ex. 15 | 80 | 20 | 35 | 250 | 74 |
| Ex. 16 | 90 | 10 | 35 | 250 | 80 |
| Ex. 17 | 0 | 100 | 80 | 250 | 66 |
| | | | | | (estimated) |
| Ex. 18 | 0 | 100 | 80 | 250 | 69 |
| | | | | | (estimated) |
| Ex. 19 | 0 | 100 | 50 | 250 | 58 |
| | | | | | (estimated) |
| Ex. 20 | 90 | 10 | 50 | 250 | 84 |
| | | | | | (estimated) |
| Ex. 21 | 90 | 10 | 60 | 250 | 100 |
| | | | | | (estimated) |
| Ex. 22 | 90 | 10 | 50 | 225 | 74 |
| | | | | | (estimated) |
| Ex. 23 | 50 | 50 | 80 | 250 | — (Pending) |

This disclosure is not limited to the particular systems, devices and methods described, as these may vary. The terminology used in the description is for the purpose of describing the particular versions or embodiments only and is not intended to limit the scope of the invention. Furthermore, as described herein, any listing of a patent document such as a U.S. Patent, U.S. Patent Application Publication, World Intellectual Property Organization publication, or foreign patent application publication means that such document is incorporated by reference in its entirety.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

As used herein, the term “about” means plus or minus 10% of the numerical value of the number with which it is being used. Therefore, about 50% means in the range of 45%-55%.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera. As a non-limiting example, each range discussed herein can be readily broken down into a lower third, middle third and upper third, et cetera. As will also be understood by one skilled in the art all language such as “up to,” “at least,” and the like include the number recited and refer to ranges that can be subsequently broken down into subranges as discussed above. Finally, as will be understood by one skilled in the art, a range includes each individual member. Thus, for example, a group having 1-3 components refers to groups having 1, 2, or 3 components. Similarly, a group having 1-5 components refers to groups having 1, 2, 3, 4, or 5 components, and so forth.

Optional or optionally means that the subsequently described event or circumstances may or may not occur. The description includes instances where the event or circumstance occurs and instances where it does not occur.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

In some aspects, the techniques described herein relate to a method for recovering lithium from black mass containing LiFePO4, including the steps of: acid baking a material including LiFePO4 in the presence of sulfuric acid at a temperature of 150-800° C., thereby producing an acid baked composition, wherein said material including LiFePO4 is either LiFePO4-containing black mass or LiFePO4 that is derived from LiFePO4-containing black mass; leaching Li+, one or more types of non-lithium cations, and SO42− from the acid baked composition with water, thereby producing an acidic leachate including dissolved Li+, one or more types of non-lithium cations, and SO42−; adding a basic reagent to the acidic leachate in one or more steps in order to precipitate salts of the non-lithium cation(s) and produce one or more solid leachate tailings and a lithium-enriched liquor including dissolved Li+ and SO42−; separating the lithium-enriched liquor from all of the one or more solid leachate tailing(s), thereby producing a product liquor including dissolved Li2SO4; and optionally: contacting the product liquor with a precipitation agent in order to precipitate Li2CO3 or LiOH and produce a lithium-depleted aqueous phase and product lithium including the precipitated Li2CO3 or LiOH and separating the product lithium from the lithium-depleted aqueous phase.

In some aspects, the techniques described herein relate to a method, wherein said material including LiFePO4 is LiFePO4-containing black mass.

In some aspects, the techniques described herein relate to a method, wherein β-spodumene is also acid baked with said material including LiFePO4.

In some aspects, the techniques described herein relate to a method, wherein said material including LiFePO4 is LiFePO4 derived from LiFePO4-containing black mass that is produced by decrepitating the LiFePO4-containing black mass at a temperature of 800-1500° C., thereby producing said derived LiFePO4.

In some aspects, the techniques described herein relate to a method, wherein said water leaching step is carried out at a temperature of 25-70° C. and for a duration of 6 hrs or less.

In some aspects, the techniques described herein relate to a method, wherein the LiFePO4-containing black mass is decrepitated with α-spodumene, thereby transforming the α-spodumene to β-spodumene.

In some aspects, the techniques described herein relate to a method, wherein the α-spodumene is in the form of floated alpha spodumene concentrate.

In some aspects, the techniques described herein relate to a method, wherein β-spodumene is also acid baked with said material including LiFePO4 in said step of acid baking.

In some aspects, the techniques described herein relate to a method, wherein said step of adding a basic reagent to the acidic leachate includes the steps of: raising a pH of the acidic leachate, with an addition of a basic reagent, to a first predetermined value at which the one or more non-lithium salts are precipitated therefrom and at which Li2SO4 remains solvated therein; separating the precipitated non-lithium salt(s) from the acid leachate containing the solvated Li2SO4; and raising a pH of the acidic leachate to a second predetermined value higher than said first predetermined value, with an addition of a basic reagent, at which Li2SO4 precipitates therefrom.

In some aspects, the techniques described herein relate to a method, wherein the precipitation agent is CO2, Na2CO3, and/or K2CO3 in order to precipitate Li2CO3.

In some aspects, the techniques described herein relate to a method, wherein the precipitation agent is NaOH, Ca(OH)2, and/or KOH in order to precipitate LiOH.

In some aspects, the techniques described herein relate to a method, wherein the LiFePO4-containing black mass includes 1-20 wt % lithium.

In some aspects, the techniques described herein relate to a method, wherein the LiFePO4-containing black mass includes 1-10 wt % lithium.

In some aspects, the techniques described herein relate to a method, wherein the LiFePO4-containing black mass includes 1-5 wt % lithium.

In some aspects, the techniques described herein relate to a method, wherein the LiFePO4-containing black mass includes 2-3.5 wt % lithium.

In some aspects, the techniques described herein relate to a method, wherein the LiFePO4-containing black mass includes 2.6-2.8 wt % lithium.

In some aspects, the techniques described herein relate to a method, wherein said acid baking is performed in an acid baking vessel chosen from rotary kilns, Waelz kilns, industrial ovens, industrial muffle furnaces, and roasting furnaces.

In some aspects, the techniques described herein relate to a method, wherein the acid baking vessel is a rotary kiln or Waelz kiln and a gaseous oxidant such as air, oxygen-enriched air or industrially pure oxygen is injected into an interior thereof.

In some aspects, the techniques described herein relate to a method, wherein the LiFePO4-containing black mass is decrepitated in a decrepitation vessel with α-spodumene, thereby transforming the α-spodumene to β-spodumene, and the decrepitation vessel is chosen from rotary kilns, Waelz kilns, industrial ovens, industrial muffle furnaces, and roasting furnaces.

1. A method for recovering lithium from electrochemical scrap waste or black mass containing LiFePO₄ or LiMnₓFe₍₁₋ₓ₎PO₄, the method comprising:
acid baking or salt baking electrochemical chemical scrap waste or the black mass containing LiFePO₄ or LiMnₓFe₍₁₋ₓ₎PO₄ in the presence of sulfuric acid or sulfur containing salt at a temperature of about 150° C. to about 350° C. for acid baking or about 150° C. to about 1000° C. for salt baking, thereby producing an acid baked or salt baked composition or;
leaching Li⁺, one or more types of non-lithium cations, and SO₄²⁻ from the acid baked or salt baked composition with water, thereby producing an acidic leachate comprising dissolved Li⁺, one or more types of non-lithium cations, and SO₄²⁻;
adding a basic reagent to the acidic leachate in one or more steps to precipitate salts of one or more non-lithium cation(s) and produce one or more solid leachate tailings and a lithium-enriched liquor comprising dissolved Li⁺ and SO₄²⁻; and
separating the lithium-enriched liquor from all of the one or more solid leachate tailing(s), thereby producing a product liquor comprising dissolved Li₂SO₄.

2. The method of claim 1, comprising:
contacting the product liquor with a precipitation agent in order to precipitate Li₂CO₃ or LiOH and produce a lithium-depleted aqueous phase and product lithium comprising the precipitated Li₂CO₃ or LiOH; and
separating the product lithium from the lithium-depleted aqueous phase.

3. The method of claim 1, wherein β-spodumene is acid baked with the electrochemical scrap waste or black mass containing LiFePO₄.

4. The method of claim 1, wherein the electrochemical scrap waste or black mass containing LiFePO₄ or LiMnₓFe₍₁₋ₓ₎PO₄ is decrepitated at a temperature of about 800° C. to about 1500° C.

5. The method of claim 1, wherein the water leaching step performed at about 25 to about 70° C. and for a duration of 6 hours or less.

6. The method of claim 1, wherein the electrochemical scrap waste or black mass containing LiFePO₄ or LiMnₓFe₍₁₋ₓ₎PO₄ is decrepitated with α-spodumene, thereby transforming the α-spodumene to β-spodumene.

7. The method of claim 6, wherein the α-spodumene is in the form of floated alpha spodumene concentrate.

8. The method of claim 1, wherein β-spodumene is also acid baked or salt baked with the electrochemical scrap waste or black mass containing LiFePO₄ or LiMnₓFe₍₁₋ₓ₎PO₄.

9. The method of claim 1, comprising adding a basic reagent to the acidic leachate by:
raising a pH of the acidic leachate, with an addition of a basic reagent, to a first predetermined value at which one or more non-lithium salts are precipitated therefrom and at which Li₂SO₄ remains solvated therein;
separating precipitated non-lithium salt(s) from the acid leachate containing the solvated Li₂SO₄; and
raising a pH of the acidic leachate to a second predetermined value higher than said first predetermined value, with an addition of a basic reagent, at which Li₂SO₄ precipitates therefrom.

10. The method of claim 2, wherein the precipitation agent is CO₂, Na₂CO₃, and/or K₂CO₃ in order to precipitate Li₂CO₃.

11. The method of claim 2, wherein the precipitation agent is NaOH, Ca(OH)₂, and/or KOH in order to precipitate LiOH.

12. The method of claim 1, wherein the electrochemical scrap waste or black mass contains 1-20 wt % lithium.

13. The method of claim 1, wherein the electrochemical scrap waste or black mass contains 1-10 wt % lithium.

14. The method of claim 1, wherein the electrochemical scrap waste or black mass contains comprises 1-5 wt % lithium.

15. The method of claim 1, wherein the electrochemical scrap waste or black mass contains comprises 2-3.5 wt % lithium.

16. The method of claim 1, wherein the electrochemical scrap waste or black mass contains 2.6-2.8 wt % lithium.

17. The method of claim 1, wherein the acid baking is performed in an acid baking vessel chosen from rotary kilns, Waelz kilns, industrial ovens, industrial muffle furnaces, roasting furnaces, and combinations thereof.

18. The method of claim 17, wherein the acid baking vessel is a rotary kiln or Waelz kiln and the acid baking is performed with gaseous oxidant such as air, oxygen-enriched air or industrially pure oxygen is injected into an interior thereof.

19. The method of claim 1, wherein the electrochemical scrap waste or black mass contains LiFePO₄ or LiMnₓFe₍₁₋ₓ₎PO₄ and is decrepitated in a decrepitation vessel with α-spodumene, thereby transforming the α-spodumene to β-spodumene, and the decrepitation vessel is chosen from rotary kilns, Waelz kilns, industrial ovens, industrial muffle furnaces, and roasting furnaces.

20. The method of claim 1, wherein the lithium is extracted in an amount of at least about 54 wt. %.

21. The method of claim 3, wherein a weight ratio of electrochemical scrap waste or black mass containing LiFePO₄ or LiMnₓFe₍₁₋ₓ₎PO₄ to β-spodumene is about 90:10 to about 10:90.
